(19) United States
(12) Patent Application Publication
(10) Pub. No.: US 2012/0134773 A1
(43) Pub. Date: May 31, 2012

(54) LIFTING CLAMP

(76) Inventors: Cornelis Nicolaas Gillesse, Wolfheze (NL); Cornelis Theodoris De Kruijf, Maarssen (NL)

(21) Appl. No.: 13/321,143

(22) PCT Filed: Mar. 10, 2010
(86) PCT No.: PCT/NL2010/050121

§ 371 Date: Feb. 15, 2012

(30) Foreign Application Priority Data
Mar. 10, 2009 (NL) 2002606

(51) Int. Cl. B66C 1/42

(52) U.S. Cl. 414/815; 294/104

(57) ABSTRACT

The invention relates to a lifting clamp comprising a frame, a first clamping part, rotatably connected to the frame and provided with a first gripping surface, a second clamping part, coupled and/or connected to the frame, provided with a second gripping surface, and arranged with respect to the first clamping part so as to clamp an object between the second gripping surface and the first gripping surface, an operating arm, connected to the first clamping part in order to rotate said first clamping part under the effect of an operating force, a lifting eye, connected to the operating arm, in which the lifting eye is pivotably coupled to the operating arm by means of an arm in order to exert the operating force on the operating arm under the effect of a hoisting force on the lifting eye which is at an angle of 90-180 degrees with respect to the direction of the operating force.

### BACKGROUND OF THE INVENTION

The invention relates to a lifting clamp.

Many lifting clamps are known, inter alia from the Applicant. Clamping devices of this type are intended in particular for use with loading and unloading devices, such as cranes and hoisting implements for lifting panel-shaped material, such as metal plates, elongate elements, etc. Objects comprising a part which can be clamped by means of the clamping device can also be lifted or moved therewith.

Such a clamping device is known, for example from U.S. Pat. No. 4,641,877 and NL-A-7414215. These documents describe a clamping device which is provided with a first clamping part and a second clamping part. The first clamping part is rotatably connected to a frame and connected to a movable lifting eye by means of a rotatably connected arm. When, for example, a plate is placed between the clamping parts, the lifting eye will slide inside or within the frame when the clamping device is being lifted, as a result of which the arm will cause the first clamping part to rotate. Consequently, the teeth of the first clamping part come into contact with the plate, will become stuck in the plate, and, in addition, the first clamping part will exert a force on the plate in the direction of the second clamping part so that the plate is clamped between the first and second clamping part. In the case of the known clamping devices, the second clamping part is also referred to as an anvil. The thickness of the material to be clamped is determined, inter alia, by the distance over which the first clamping part can be displaced.

Reference is made to the more recent WO2008069664 and WO2008069665 in the name of the Applicant which disclose various lifting clamps.

NL7003662 describes a lifting clamp, in which the shank of the lifting eye is designed in the form of two sections which pivot with respect to one another. In this case, the lifting eye itself pivots about an axis at right angles to a pivot pin which is situated outside the clamp housing between the shank sections. As a result thereof, this lifting damp can hoist objects, such as plates, vertically, but also in a horizontal position. When hoisting objects in the horizontal position, the line of action of the hoisting force may not always be in line with the line of action of the operating force which enables the lifting clamp to clamp. The drawback in this case is that situations occur, that is to say orientations of the lifting clamp, in which the hoisting force is no longer converted into an operating force, thus resulting in the lifting clamp losing its clamping action and/or the clamping force being significantly reduced. Thus, the lifting clamp cannot, for example, be used upside down.

Also in the case of FR-1482695 and U.S. Pat. No. 2,284,006 and U.S. Pat. No. 3,336,068, the lifting clamp can clamp even if the lines of action of the hoisting force and the operating force are not parallel. In these cases, however, the problem of a reduced clamping force usually occurs sooner.

These lifting clamps which, as such, have been known for a long time can be improved upon, thus for example making other applications possible.

### SUMMARY OF THE INVENTION

It is an object of the invention to provide an improved lifting clamp.

It is a further and/or additional object of the invention to provide a lifting clamp having a wider and/or alternative area of application.

To this end, the invention provides a lifting clamp comprising a frame, a first clamping part, rotatably connected to the frame and provided with a first gripping surface, a second clamping part, coupled and/or connected to the frame, provided with a second gripping surface, and arranged with respect to the first clamping part so as to clamp an object between the second gripping surface and the first gripping surface, an operating arm, connected to the first clamping part in order to rotate said first clamping part under the effect of an operating force, a lifting eye, connected to the operating arm, in which the lifting eye is pivotably coupled to the operating arm by means of an arm in order to exert the operating force on the operating arm under the effect of a hoisting force on the lifting eye which is at an angle of 90-180 degrees with respect to the direction of the operating force.

The invention furthermore relates to a method for hoisting an object using at least two lifting clamps according to the invention, in which lifting clamps are arranged at a distance from one another on the object to be hoisted and engage the object in a clamping manner, the lifting clamps are lifted up, as a result of which the object is at least partially suspended from the lifting clamps, and one end of the object, which end is situated at a distance from a connecting line through the engagement part of two of the lifting clamps, and the connecting line are displaced vertically with respect to one another, as a result of which the object is at least partially rotated about an axis of rotation substantially parallel to the connecting line.

With the conventional lifting clamps of the above-described type, the hoisting force, which is applied to the lifting eye and the operating force which activates the damping parts work along virtually the same line of action. Usually, the forces even work in the same direction. It was found that it is possible, by means of the connection of the lifting eye via the arm, to safely apply the lifting clamp in situations in which the hoisting force works in an opposite direction to the direction of the operating force of the lifting clamp. At least a large component of the hoisting force works in an opposite direction to the operating force.

By means of the combination of the selected arm, lifting eye and operating arm and the respective pivoting action between them, it is possible, according to the method, to hoist objects and rotate them during hoisting about an axis using two lifting clamps.

In one embodiment, the hinges of the lifting eye, the arm and the operating arm, respectively, comprise mutual stops for limiting the pivot angles, thus making it possible to rotate an object to be hoisted while it remains clamped in the lifting clamp.

In addition, it is possible to ensure a sufficient clamping action even when the hoisting force is oriented at 180 degrees with respect to an operating force for achieving clamping, which is very important for the safety of operation.

In one embodiment, the mutual distance and stops of the hinges are configured such that, in use, a line of action of the hoisting force which works in a direction opposite to the operating force is situated outside the frame.

In one embodiment, the operating arm comprises a guide in the frame and the guide determines of fixes the line of action of the operating force. In this case, the course of the guide determines the direction of the operating force. Thus, the guide arm can, for example, comprise a pin which runs in a slotted hole in the frame. This slotted hole will in many cases be oriented parallel to and along the longitudinal axis of a slot which is discussed below.

In one embodiment, the lifting eye pivots about axes of rotation substantially parallel to the axis of rotation of the first clamping part. Thus, a hoisting force is still able to cause the clamping parts to clamp when it is applied to the lifting eye, even in the direction opposite to the required operating force which is necessary to cause the operating arm to clamp the clamping parts. As a result thereof, it is possible to operate the lifting clamp effectively upside down. It is also possible to retain the clamping action while the hoisting force changes (relative) direction. It is then possible to manipulate an object with regard to its spatial orientation while the lifting clamp continues to clamp.

In one embodiment, the lifting eye is pivotably or hingably connected to the arm.

In one embodiment, the lifting damp furthermore comprises a second arm, pivotable between the first arm and the operating arm, pivotably connected to the first arm and pivotably connected to the operating arm. It was found that by using, for example, two arms, the hoisting force can be turned approximately 180 degrees. In particular when hoisting very heavy loads, often of several tonnes, it has thus been possible to use the lifting clamp upside down, while the length of the arms and thus the vulnerability could be reduced.

In one embodiment, the first arm and/or, if present, the second arm comprises a hinge for pivoting about a pivot pin transversely to the pivoting direction of the pivoting coupling of the lifting eye to the first arm. Consequently, it is possible to prevent, at least partially, a crooked or out of true load on the arms. In one embodiment thereof, however, the swing of said hinge is limited to prevent it from swinging back completely. For most applications, a pivot angle of approximately ±10-20 degrees (20-40 degrees full swing) has proved sufficient to this end. The sign “±” in this case means 10 degrees in one direction and 10 degrees in the other direction relative to the longitudinal axis.

In one embodiment, the lifting clamp furthermore comprises at least one stop in the hinges between the lifting eye and the operating arm. As a result thereof, the force can safely be turned up to 180 degrees.

In one embodiment, one of the pivoting arms has a stop against the frame. This makes it readily possible to change the direction of the hoisting force, while keeping the line of action of the hoisting force as close as possible to the line of action of the operating force of the operating arm.

In one embodiment, the frame comprises a bottom plate and a top plate which are connected to one another and have the clamping parts fitted in between. In one embodiment thereof, these plates are connected to one another by means of connecting parts, such as connecting pins In one embodiment, the connecting pins at the operating arm form a stop for one of the pivoting arms.

In one embodiment, the frame comprises two legs with a slot in between, and a clamping part is fitted to each leg in order to clamp an object between the legs. In one embodiment, in operation, the operating force is directed along a line between the legs. In particular, the operating force works in a direction opposite to the direction of opening of the legs. Due to the pivoting arms, a hoisting force directed away from the legs can still enable the clamp to clamp.

In one embodiment of the method, at least a third lifting clamp according to the invention engages the object at a distance from the connecting line, at the end of the object to be hoisted. The method in this case comprises a step where the third lifting clamp and the connecting line are displaced vertically with respect to one another so that the object is at least partially rotated about an axis of rotation parallel to the connecting line. During application, three lifting clamps arranged at the corners of a triangle engage the object Due to the kind of arms and hinges between the lifting eye and the operating arm, the object remains safely clamped during rotation.

In one embodiment, it is also possible to use four lifting clamps arranged at the corners of a quadrangle, thus making it possible for the object to be rotated by changing the height of a connecting line through the two other lifting clamps and the connecting line through the two first lifting clamps with respect to one another. As a result thereof, the object is rotated while at least partially suspended from the lifting clamps and being clamped safely.

It will be clear that the various aspects described in the present patent application and/or illustrated in the figures can be combined and/or may each be considered individually for a divisional patent application.

### BRIEF DESCRIPTION OF THE FIGURES

The attached figures show an embodiment of a lifting clamp according to the invention, in which:

FIG. 1 shows a front view of an embodiment of a lifting clamp according to the invention;

FIG. 2 shows a cross section of a part of the lifting clamp from FIG. 1 as indicated;

FIG. 3 shows a use of the lifting clamp from FIG. 1.

### DESCRIPTION OF EMBODIMENTS

The figures show the lifting clamp or clamping device 1 having a frame 2, in which an operating arm 6 is arranged so as to be movable along a straight line part (I) by means of a slotted hole 4 and guide 5. A lifting eye 3 is operatively connected to the operating arm 6.

The frame 2 has a slot 7 for accommodating a part of an object which has to be clamped and consequently has two legs on either side of the slot 7.

A first clamping part 8 on a rotary shaft 9 is pivotably or rotatably connected to the frame 2. Clamping part 8 is furthermore connected to the operating arm 6 by means of a rotary shaft 10, at a distance from the rotary shaft 9.

Clamping part 8 has a gripping surface 11 which is situated at an increasing distance from the rotary shaft 9. The distance in this case increases as the slot 7 is entered. The frictional resistance of the gripping surface is high here due to a toothing. The gripping surface 11 in this case has teeth, preferably gripping in the direction into or out of the slot 7. It is also possible to have a gripping surface 11 different from that shown, preferably a gripping surface 11 which results in less friction in the direction into the slot 7 than in the direction out of the slot 7.

Gripping surface 11 is situated at a distance from rotary, shaft 9. Operating arm 6 engages with clamping part 8 at the end opposite gripping surface 11. In operation, a lever is thus created comprising, at one end, the gripping surface 11 rotating about rotary shaft 9 and, at the other end, rotary shaft 10 where operating arm 6 engages with clamping part 8.

Situated in the slot 7 opposite the first clamping part 8 is a second clamping part 12. Said second clamping part 12 is provided with a gripping part 13, also referred to as an anvil, and also having a gripping surface.

The damping device 1 is furthermore provided with a lock comprising lever operator 14 in order to lock the operating arm 6 in position and thus lock the first clamping part 8 in position.

In many embodiments, the clamping part 8 is prestressed or biased by means of a spring 15, in many cases, as illustrated, by means of operating arm 6.

In this embodiment, lifting eye 3 is pivotably connected to the operating arm 6 by means of a first pivoting arm 16 and a second pivoting arm 17. Force line of action W and a hoisting force F_{H} acting on lifting eye 3 along the line of action W are indicated by a dashed line. By means of the connection of lifting eye 3, it is possible to exert a hoisting force F_{H} which is directed away from the slot 7, and which enables the clamping parts to clamp.

In this embodiment, the lifting eye 3 is pivotably connected to an end of the first pivoting arm 16 by means of hinge 18. The pivot pin of hinge 18 is substantially parallel to rotary shaft 9.

At a second end, pivoting arm 16 is pivotably connected to an end of second pivoting arm 17 by means of hinge 19. Hinge 19 pivots about a pivot pin substantially parallel to rotary shaft 9. Furthermore, the second pivoting arm 17 is pivotably connected to operating arm 6, in this case simply by fitting it to a pin 5 which also provides the guidance in the slotted hole 4. By widening arm 17, the latter comes into contact with the frame, in particular with pin 23.

Slotted hole 4 enables the pin 5 to move along a linear portion of line (I), in order to cause clamping part 8 to rotate about rotary shaft 9.

One purpose of connecting parts which connect lifting eye 3 and operating arm 6 is to make it possible to exert a hoisting force in the direction away from (out of) slot 7, while still causing clamping parts 8, 13 to exert a clamping force. In this embodiment, the pivoting arms 16, 17 are chosen for this purpose. Here, these pivoting arms 16, 17 have stops 20, 21, 22, so that the above-described hoisting force F_{H} results in a tensile force F_{T} on the operating arm 6 so that clamping part 8 is subsequently operated.

Pivoting arm 17 has a stop 22, in this case a stop face 22, which strikes against the frame of lifting clamp 1. Here, stop face 22 strikes against pin 23 (or pin 23′, respectively, if pivoting in the other direction) which connects the bottom plate and top plate of frame 2 to one another. Thus, the swing of arm 17 is limited to approximately 20°-30° (or approximately 40°-60° full swing).

Pivoting arm 17 has a stop (face) 21 which lies against a stop of pivoting arm 16, as illustrated; here, it is formed by an integral part of the central portion of pivoting arm 16. As a result thereof, the pivot angle is limited to approximately ±95°-105° (approximately 190°-210° full swing). Another end of the integral part has a stop 20 which lies against a stop face of lifting eye 3. Consequently, the pivot angle is limited to approximately ±70°-90° (approximately 140°-180° full swing). In particular, the swing is limited here to ±75°-80° (approximately 150°-160° full swing). In this case, pivoting arm 16 has legs at the ends. By means of the arms, hinges and stops, the hoisting force F_{H} is turned by approximately 180 degrees and converted into a tensile force F_{T} which provides the clamping action of the lifting clamp. Effectively, the stops of the hinges here ensure that the hoisting force always leads to a resultant force on the operating arm 6. Lifting eye 3 thus pivots in the plane of the drawing.

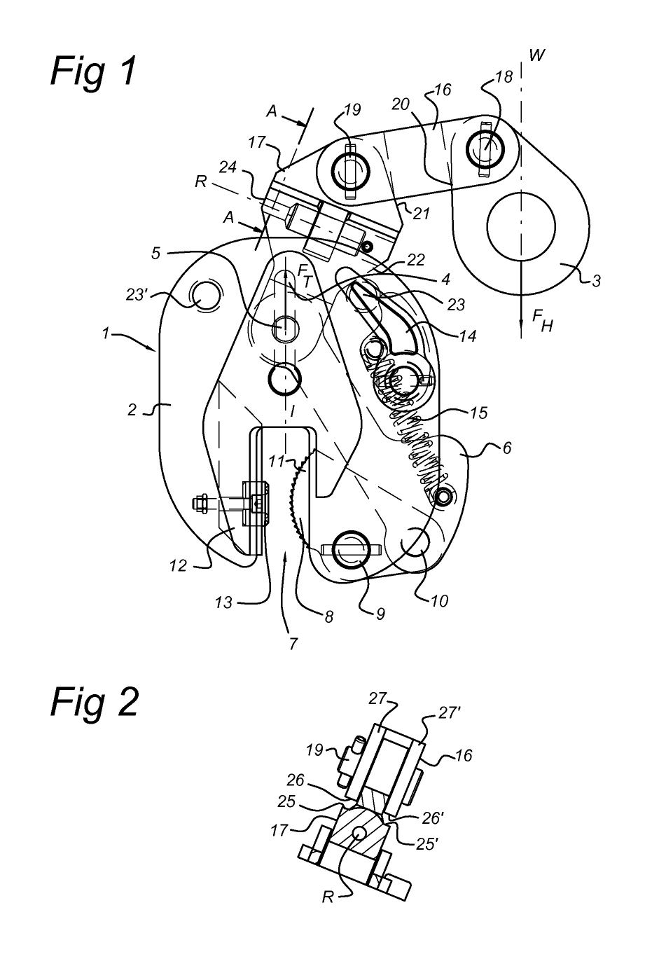

In order to prevent crooked of out of true loads from occurring on the pivoting arms, and/or to prevent these as much as possible, here one of the arms 16, 17, in this case arm 17 which is connected to the operating arm, is provided with a hinge 24 which enables rotation about line (R). Axis of rotation R is situated outside the frame. Furthermore, axis of rotation R is situated substantially in the plane of the lifting clamp. In FIG. 2, the arm is represented in partial cross section, as is the case in FIG. 1. In order to prevent the lifting clamp from swinging back completely, the mutually pivoting parts are provided with stops 25, 25′ and stops 26 and 26′ (for the sake of clarity, reference numerals 26 and 26′ here refer to the hatched pans. If desired, it is also possible for parts of the legs 27, 27′ to act as a stop). By means of hinge, lifting eye 3 can thus pivot out off the plane of the drawing to a limited degree. In the embodiment, this pivot angle is limited to approximately 20°-40° (full swing). This view also shows how pivoting arm 16 ends in legs 27 and 27′ with this embodiment.

In effect, the above-described embodiment diverts the hoisting force in a manner which, on the one hand, is simple and, on the other hand, results in as few uncontrolled and undesired forces as possible on the lifting clamp or on an object to be hoisted. Moreover, it is possible to rotate an object which is to be hoisted and suspended from several lifting clamps about a horizontal axis. In general an axis which is at an angle to the line of action of the force of gravity.

The lifting clamp according to the invention is particularly suited for hoisting a cover 100 in a clamping manner, such as a cover 100 of a reaction vessel, in the direction of the arrow. Due to the pivoting arms, the lifting clamp can be used upside down.

The operation of lifting, for example, the cover 100 is as follows. In the at-rest position, the lifting eye 3 and the guide 5 may rest in the slotted hole. The longitudinal axis of the slotted hole in this case determines the line of action of the operating force. Here, the longitudinal axis of the slotted hole coincides with the axis of slot 7. In the at-rest position, that part of the first gripping surface 11 which is closest to the rotary shaft 9 will in this case be closest to the second gripping surface. The distance between the gripping surfaces will approximately be at its maximum. The guide 5 can move freely in the slotted hole 4, as a result of which the operating arm 6 can move freely and thus cause the first clamping part 8 to pivot about rotary shaft 9. The longitudinal axis of the slotted hole in this case determines the line of action of the operating force. When, for example, a part of the cover 100 is positioned in the slot 7, lifting eye 3 can be displaced with respect to the object and frame 2, in which case guide 5 moves into the slotted hole 4 towards the side facing away from the slot 7. As a result thereof, the first clamping part, activated by operating arm 6, will pivot about rotary shaft 9. Consequently, as a result of the increase in the distance between the gripping surface 11 and the rotary shaft 9, the distance between the gripping surfaces will be reduced until both surfaces of the clamping parts 8 and 12 bear against the surfaces of the object. When lifting is continued, the force which clamping pan 8 exerts on the surfaces of the object increases. The teeth of gripping surface 11 may penetrate the surface, and due to the weight of the object to be hoisted, the first clamping part 8 is subjected to a force in the direction away from the slot 7. This force results in a force which pushes the object against the second clamping part, as a result of which the toothing of the second gripping surface can also penetrate the surface of the object, thus ensuring reliable clamping.

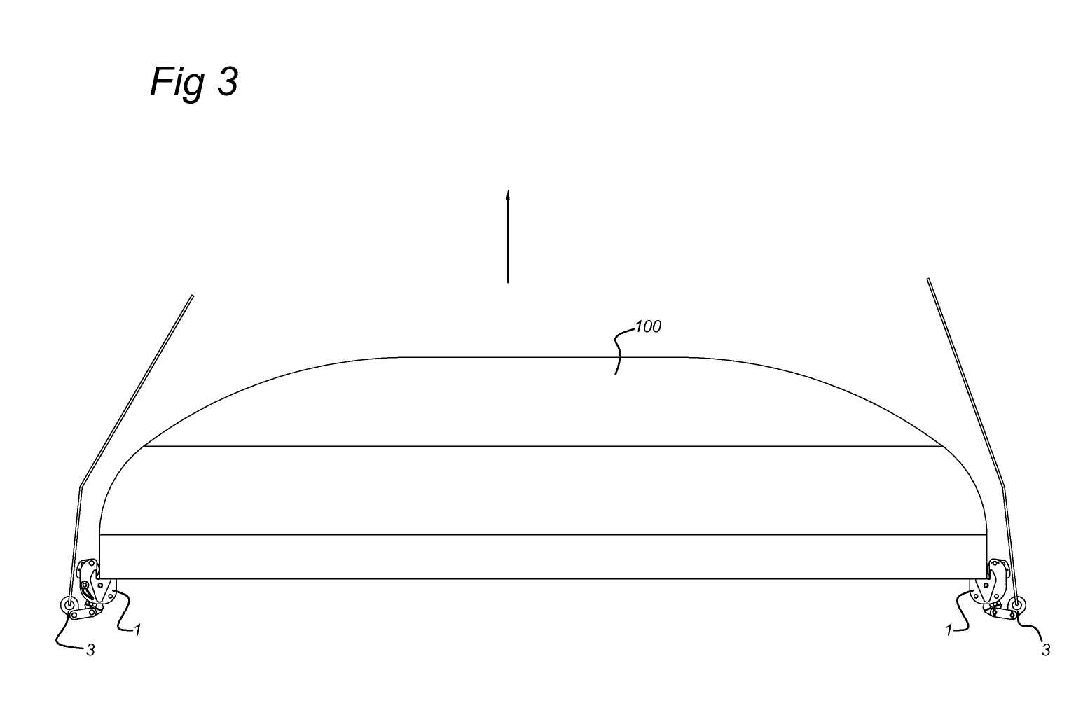

In particular, an object can be turned around/upside dawn while it is suspended from the lifting clamps. As is illustrated in FIG. 3, an object to be hoisted is suspended from several lifting clamps, usually at least three. In many cases, four spaced-apart lifting clamps will be used By means of the lifting clamp of the invention, it is possible to rotate an object to be hoisted while it is clamped in and suspended from at least two of the lifting clamps, for example about a connecting line through the at least two clamping lifting damps. This is usually effected by vertically displacing the other lifting clamps, which engage the object at a distance from the connecting line of the previous two lifting clamps, with respect to the connecting line. This is made possible by the arms and the hinges. In effect, the spatial orientation of an object can be changed in this manner while the object is suspended from the lifting clamps.

It will be clear that the above description has been given in order to illustrate the functioning of preferred embodiments of the invention, and not in order to limit the scope of the invention. On the basis of the above explanation, many variations which fall within the spirit and the scope of the present invention will be obvious to a person skilled in the art.

1. A lifting clamp comprising:
a frame;
a first clamping part, rotatably connected to the frame and provided with a first gripping surface;
a second clamping part, coupled and/or connected to the frame, provided with a second gripping surface, and arranged with respect to the first clamping part so as to clamp an object between the second gripping surface and the first gripping surface,
an operating arm, connected to the first clamping part in order to rotate said first clamping part under the effect of an operating force,
a lifting eye, connected to the operating arm,
in which the lifting eye is pivotably coupled to the operating arm by means of an arm in order to exert the operating force on the operating arm under the effect of a hoisting force on the lifting eye which is at an angle of 90-180 degrees with respect to the direction of the operating force.

2. The lifting clamp according to claim 1, wherein the hinges of the lifting eye, the arm and the operating arm, respectively, comprise mutual stops for limiting the pivot angles, thus making it possible to rotate an object to be hoisted while it remains clamped in the lifting clamp.

3. The lifting clamp according to claim 3, wherein the mutual distance and stops of the hinges are configured such that, in use, a line of action of the hoisting force which works in a direction opposite to the operating force is situated outside the frame.

4. The lifting clamp according to claim 1, wherein the operating arm comprises a guide in the frame and the guide determines the line of action of the operating force.

5. The lifting clamp according to claim 1, wherein the lifting eye is pivotable about axes of rotation substantially parallel to the axis of rotation of the first clamping part.

6. The lifting clamp according to claim 1, wherein the lifting eye is pivotably connected to the arm.

7. The lifting clamp according to claim 1, furthermore comprising a second arm, pivotable between the first arm and the operating arm, pivotably connected to the first arm and pivotably connected to the operating arm.

8. The lifting clamp according to claim 7, wherein the first arm and the second arm comprises a hinge for pivoting about a pivot pin transversely to the pivoting direction of the pivoting coupling of the lifting eye to the first arm.

9. The lifting clamp according to claim 1, furthermore comprising at least one stop in the hinges between the lifting eye and the operating arm.

10. The lifting clamp according to claim 1, wherein one of the pivoting arms has a stop against the frame.

11. The lifting clamp according to claim 1, wherein the frame comprises a bottom plate and a top plate which are connected to one another and have the clamping parts which fitted in between.

12. The lifting clamp according to claim 1, wherein the frame comprises two legs with a slot in between, and a clamping part is fitted to each leg in order to clamp an object between the legs.

13. The lifting clamp according to claim 12, wherein the arm is designed to convert a hoisting force directed away from the legs into an operating force.

14. Method for hoisting an object using at least two lifting clamps according to claim 1, wherein lifting clamps are arranged at a distance from one another on the object to be hoisted and engage the object in a clamping manner, the lifting clamps are lifted up, as a result of which the object is at least partially suspended from the lifting clamps, and one end of the object, which end is situated at a distance from a connecting line through the engagement part of two of the lifting clamps, and the connecting line are displaced vertically with respect to one another, as a result of which the object is at least partially rotated about an axis of rotation substantially parallel to the connecting line.

15. The method according to claim 14, wherein at least a third lifting clamp according to the invention engages the object at a distance from the connecting line, at the end of the object, and the third lifting clamp and the connecting line are displaced vertically with respect to one another so that the object is at least partially rotated about an axis of rotation substantially parallel to the connecting line.
